(19) United States
(12) Patent Application Publication
(10) Pub. No.: US 2017/0335599 A1
(43) Pub. Date: Nov. 23, 2017

(54) GUARD FOR A LATCH TO PREVENT OPENING

(71) Applicant: SAM CASTERNOVIA, WARREN, NJ (US)

(72) Inventor: SAM CASTERNOVIA, WARREN, NJ (US)

(21) Appl. No.: 15/157,963

(22) Filed: May 18, 2016

(51) Int. Cl. E05B 15/12; E05C 19/18; E05C 17/16

(52) U.S. Cl. CPC E05B 17/2023; E05C 17/166; E05C 19/184

(57) ABSTRACT

A door latch locking guard 30 for maintaining a door locked, with the door latch having a latch arm 12 and a swinging arm 14 for engaging the latch arm to lock the door. The protective locking guard 30 has a plate 32 attached to a locking housing 34, with the locking housing 34 having an internal passageway 36 for receiving therethrough the swinging arm 14 of the door latch. The plate 32 has a notch 38 for placing over and engaging the latch arm 12 of the door latch. A locking pin 40 is also provided for inserting through openings in the locking housing 34, and through the swinging arm 14 when it is inside the locking housing 34.

### FIELD OF THE INVENTION

This invention relates to a locking guard that is placed on a typical door latch to prevent the latch from being opened by a person on the other side of the door.

### BACKGROUND OF THE INVENTION

Door latches are typically used to lock a door, and also allows the door to be partially opened without opening the latch. The typical latch includes a fixed latch arm 12 mounted on the door, and a swinging arm 14 which is mounted next to the door and is moved to engage the latch arm 12 to lock the door.

The problem with such door latches is that they are not secure, since devices have been developed that can be slid through the door latch to unlock the latch from outside the door.

The present invention has been developed to solve this problem, by preventing someone outside the door from inserting a device to open the door latch.

### DESCRIPTION OF THE PRIOR ART

There are a number of prior art patents that provide improved door latches, but they have not solved the problem.

U.S. Pat. No. 7,905,525 shows a U-shaped latch cover. U.S. Pat. No. 4,062,578 shows an enlarged ball 23 to prevent the latch from being completely opened. U.S. published patent application no. 2015/0097381 discloses a ball locking member 37 for a door latch. U.S. Pat. No. 4,229,030 discloses a safety door fastening device to retain and limit the angle of openings.

Thus, the prior art patents do not disclose the present invention.

### OBJECTS OF THE INVENTION

It is an object of the present invention to provide a locking guard which is placed over a door latch to make it secure, so that the door latch cannot be unlatched from outside the door.

It is another object of the present invention to provide a locking guard which is placed through the two horizontal members of the door latch to make it secure, so that the door latch cannot be unlatched from outside the door.

Another object of the present invention is to provide a locking guard which is inexpensive and easy to install, and easy to remove from the door latch.

Another object of the present invention is to provide a locking guard that allows the existing door lock to open partially as designed to view outside the door and still be secure.

### SUMMARY OF THE INVENTION

The present invention provides a door latch locking guard 30 for maintaining a door locked, with the door latch having a latch arm 12 and a swinging arm 14 for engaging the latch arm to lock the door. The protective locking guard 30 has a plate 32 attached to a locking housing 34, with the locking housing 34 having an internal passageway 36 for receiving there through the swinging arm 14 of the door latch. The plate 32 has a notch 38 for placing over and engaging the latch arm 12 of the door latch. A locking pin 40 is also provided for inserting through openings in the locking housing 34, and through the swinging arm 14 when it is inside the locking housing 34. As a result, the locking guard 30 prevents the door latch from being opened from the other side of the door, while still allowing the latch arm 12 to travel along the swing arm 14 for partial opening of the door while securing it from opening. The present invention also provides a second embodiment of a locking guard.

### BRIEF DESCRIPTION OF THE DRAWINGS

FIG. 1 shows a typical door latch without the locking guard of the present invention installed on the door latch;

FIG. 2 shows the locking guard 30, including the plate and notch section attached to the locking housing of the locking guard;

FIG. 3 shows the locking housing 34 of the locking guard in a partially unlocked position;

FIG. 4 shows the locking housing 34 of the locking guard in a fully locked position;

FIG. 5 shows the locking housing 34 of the locking guard in a fully locked position with the locking pin inserted in the locking guard;

FIG. 6 shows the removal of the locking guard 30 from the latch 12;

FIG. 7 shows a detailed perspective view of locking guard 30;

FIG. 8 shows a second embodiment of the present invention using a modified locking guard 30′;

FIG. 9 shows the second embodiment in a partially locked position;

FIG. 10 shows the second embodiment in a fully locked position; and

FIG. 11 shows a detailed perspective view of the locking guard 30′.

### DETAILED DESCRIPTION OF THE FIRST EMBODIMENT

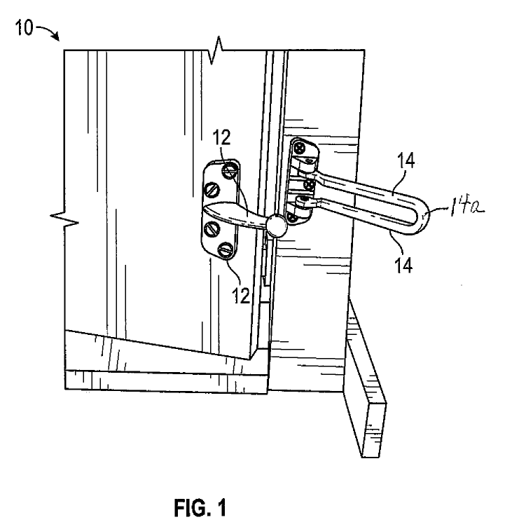

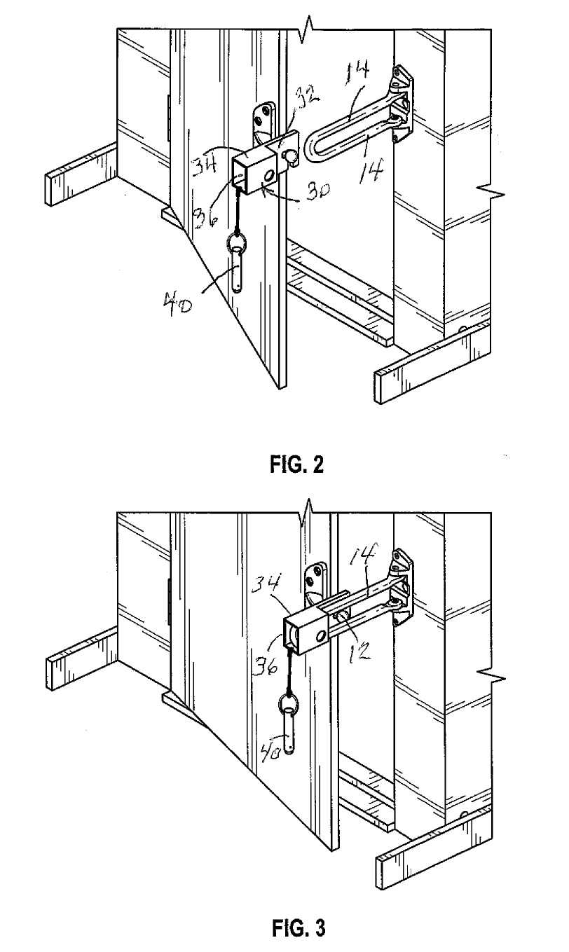

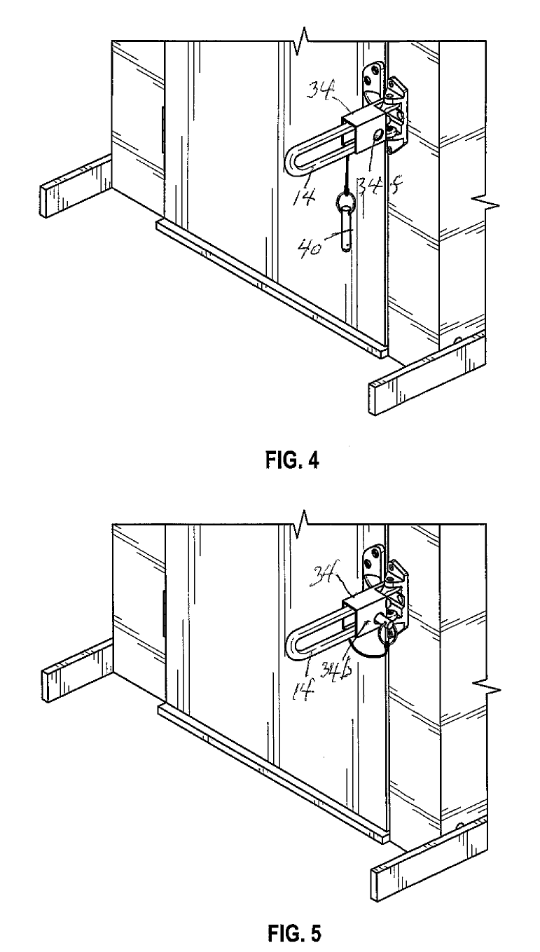

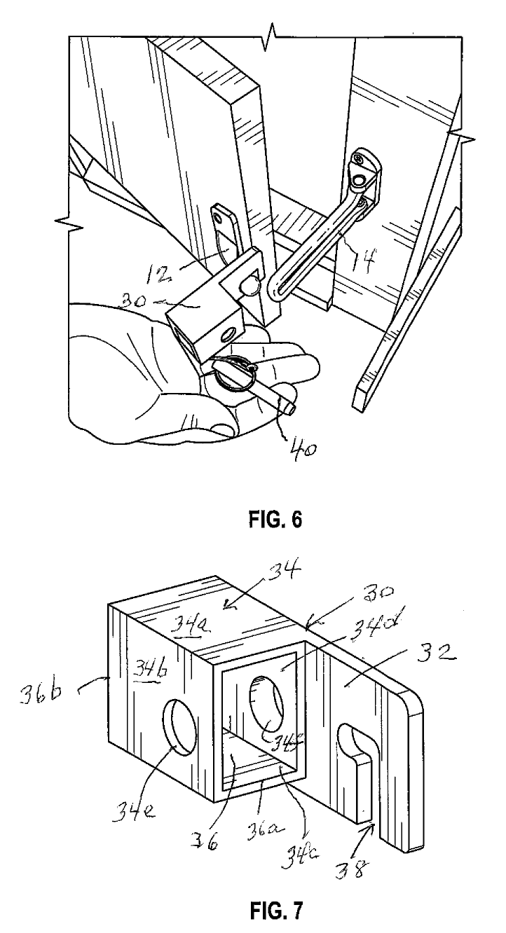

Referring to FIGS. 1 to 7, they show a door latch security device 10. The typical door latch security device 10 includes a fixed latch engagement arm 12 configured to obstruct a swinging arm 14.

The present invention provides a protective locking guard 30, which includes a flat plate 32 attached to a locking housing 34 having an internal passageway 36 for receiving therethrough the swinging arm 14. The passageway 36 includes a front opening 36a and a rear opening 36b formed in locking housing 34. The locking housing 34 is closed on the 4 remaining sides 34a, 34b, 34c and 34d.

The plate 32 also includes a notch 38 for placing over and engaging latch arm 12. Locking housing 34 also includes 2 openings 34e and 34f formed in sides 34a and 34b, for receiving a locking pin or rod 40 for securely locking the door latch 12, 14.

As a result, the locking guard 30 prevents the door latch from being opened from the other side of the door, while still allowing the latch arm 12 to travel along the swing arm 14 for partial opening of the door while securing it from opening.

### DETAILED DESCRIPTION OF THE SECOND EMBODIMENT

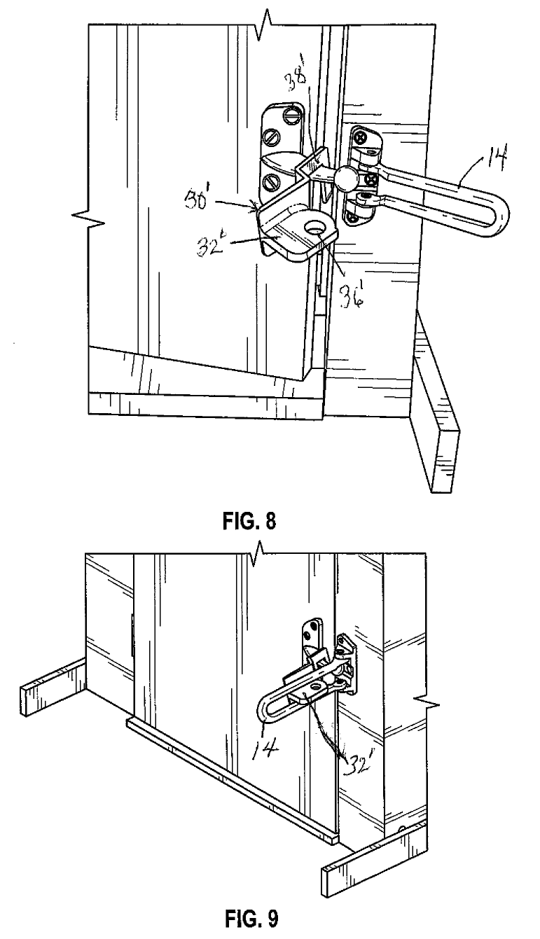

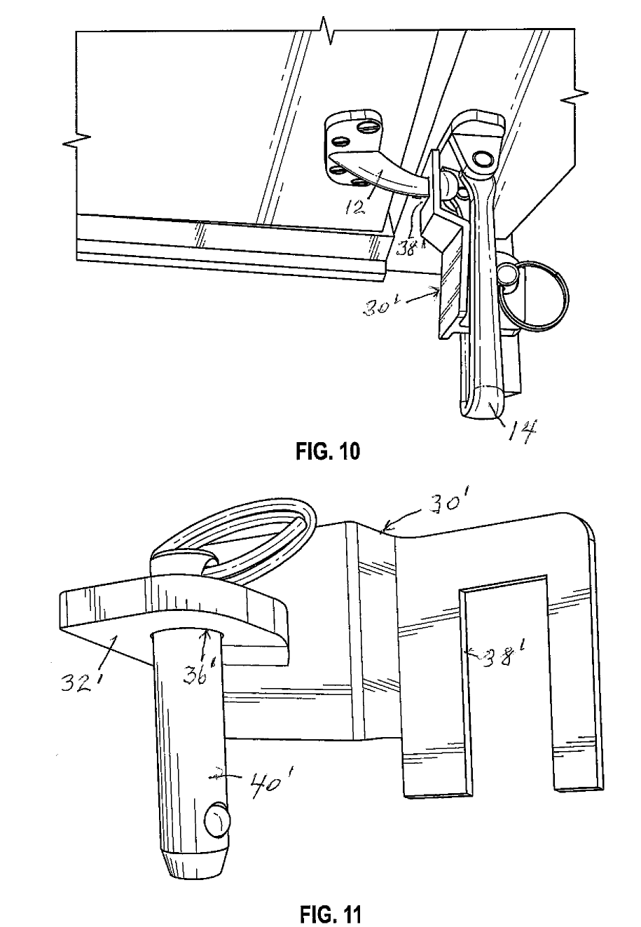

Referring to FIGS. 8 to 11, they show a door latch security device 10′. The typical door latch security device 10′ includes a fixed latch engagement arm 12 configured to obstruct a swinging arm 14.

The present invention provides a second embodiment showing a protective locking guard 30′, which includes a flat horizontal plate 32′ and also includes a notch 38′ for placing over and engaging latch arm 12. The horizontal plate 32′ passes through the horizontal bars of the swinging arm 14 to lock the latch in place, as shown in FIG. 8. Flat plate 32′ includes a hole 36′ for receiving therethrough a locking pin 40′ to hold the locking guard in place.

As a result, the locking guard 30′ prevents the door latch from being opened from the other side of the door, while still allowing the latch arm 12 to travel along the swing arm 14 for partial opening of the door while securing it from opening.

### Operation of the Invention

### First Embodiment

in operation, the door is latched with latch arm 12 and swinging arm 14. To install protective locking guard 30, the door is unlatched and the door is moved to its open position. Then, the notch 38 is placed over the latch arm 12. Next, the internal passageway 36 of locking housing 34 is mounted on the end 14a of swinging arm 14, and is moved or slid along the swinging arm 14 toward the door until the door is locked. Next, locking rod 40 is passed through opening 34e, through the swinging arm 14, and through the opening 34f for additional security.

To release the locking guard 30 of the present invention, the locking rod 40 is pulled out of openings 34e and 34f, and then locking housing 34 is slid off of the swinging arm 14. This rearward movement of the locking housing 34 also removes notch 38 from latch arm 12, and the door is unlocked and opens.

As a result, the locking guard 30 prevents the door latch from being opened from the other side of the door. However, when engaged, it still allows the latch arm 12 to travel along the swing arm 14 for partial opening of the door while securing it from opening.

### Second Embodiment

In operation, the door is latched with latch arm 12 and swinging arm 14. To install protective locking guard 30′, the door is unlatched and the door is moved to the closed position. Then, the notch 38′ is placed over the latch arm 12. Next, the horizontal plate 32′ is moved between the horizontal bars of swinging arm 14 to lock the latch in place. Next, the locking pin 40′ is inserted through hole 36′ to hold the locking guard 30′ in place.

To release the locking guard 30′ of the present invention, the locking pin 40′ is pulled out of opening 36′. Then the horizontal plate 32′ is removed from between the horizontal bars of swing arm 14. Then, notch 38′ is removed from latch arm 12, and the door is unlocked and opens.

As a result, the locking guard 30′ prevents the door latch from being opened from the other side of the door. However, when engaged, it still allows the latch arm 12 to travel along the swing arm 14 for partial opening of the door while securing it from opening.

### Advantages of the Present Invention

It is an advantage of the present invention to provide a locking guard which is placed over a door latch to make it secure, so that the door latch cannot be unlatched from outside the door.

Another advantage of the present invention is to provide a locking guard that allows the existing door lock to open partially as designed and still be secure.

It is another advantage of the present invention to provide a locking guard which is inexpensive and easy to install, and easy to remove from the door latch.

It is another advantage of the present invention to provide a locking guard that allows the existing door lock to open partially as designed to view outside the door and still be secure.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A door latch locking guard 30 for maintaining a door locked, having a door latch having a latch arm 12 and a swinging arm 14 for engaging the latch arm to lock the door, while still allowing the latch arm 12 to travel along the swinging arm 14 for partial opening of the door while securing the door from opening, comprising:
a) a protective locking guard 30, having a plate 32 for attaching to an existing a swinging arm 14;
b) a locking housing 34 having an internal passageway 36 for receiving therethrough said existing swinging arm 14 of the door latch;
c) the plate 32 having a notch 38 for placing over and engaging the swinging arm 14 of the door latch; and
d) a locking pin 40 for inserting through two openings in the locking housing 34 and through the swinging arm 14 when the swinging arm is inside the locking housing 34, in order to prevent the door latch from being opened from an opposite side of the door.

2. A door latch locking guard 30′ for maintaining a door locked, having a door latch having a latch arm 12 and a swinging arm 14 for engaging the latch arm to lock the door, while still allowing the latch arm 12 to travel along the swinging arm 14 for partial opening of the door while securing the door from opening, comprising:
a) a protective locking guard 30′, having a horizontal plate 32′ and a vertical notch member 38′ for placing over and engaging the existing swinging arm 14 of the door latch;
b) said horizontal plate 32′ having an opening 36′ for passing through the horizontal arms of said swinging arm 14; and
c) said locking pin 40′ for inserting through opening 36′ in the locking guard 30′, in order to prevent the door latch from being opened from the other side of the door.
